(19) United States
(12) Patent Application Publication
(10) Pub. No.: US 2010/0052913 A1
(43) Pub. Date: Mar. 4, 2010

(54) Method and Apparatus for Patient-Staff Identification System

(75) Inventors: Michael J. McHugh, Dracut, MA (US); Ken A. Riley, Fort Myers, FL (US); Douglas Richard, Tilton, NH (US)

Correspondence Address: HAYES, SOLOWAY P.C., 175 CANAL STREET, MANCHESTER, NH, 03101, US

(73) Assignee: SECURE CARE PRODUCTS, INC., Concord, NH (US)

(21) Appl. No.: 12/204,219

(22) Filed: Sep. 4, 2008

(51) Int. Cl. G08B 23/00

(52) U.S. Cl. 340/573.1

(57) ABSTRACT

The system contains a proximity sensor mounted in a patient room. A facility employee wears an employee identification device. The employee identification device is in communication with the proximity sensor. A display device is in communication with the proximity sensor. The display device displays information from the employee identification device.

### FIELD OF THE INVENTION

The present invention is generally related to a method and system for providing security to facilities, and more particularly is related to a system for individuals under the care of a facility to accurately identify agents of the facility.

### BACKGROUND OF THE INVENTION

One of the many fears of a hospital or similar facility is that a patient, more specifically a newborn, is abducted while under the care of the facility. While increases in security measures has effectively decreased the number of infant abductions that take place each year from medical care facilities, more needs to be done. Recently, in Lubbock, Tex., a woman wearing hospital scrubs went into a mother's room and took her baby. The woman had been in the mother's room several times before the baby was taken, giving the mother that she was an employee of the hospital and someone to be trusted, but she was not a nurse with the hospital. A mother generally does not know who is staffed at the hospital and regularly releases her newborn to strangers she believes are nurses for tests, shots, and various natal care. Scrubs are not difficult to come by and badges are not difficult to reproduce. As a result, a mother has no way of knowing whether the nurse who is taking her newborn is, in fact, a nurse with the hospital.

Thus, a heretofore unaddressed need exists in the industry to address the aforementioned deficiencies and inadequacies.

### SUMMARY OF THE INVENTION

Embodiments of the present invention provide a system and method for identifying facility employees. Briefly described, in architecture, one embodiment of the system, among others, can be implemented as follows. The system contains a proximity sensor mounted in a patient room. A facility employee wears an employee identification device. The employee identification device is in communication with the proximity sensor. A display device is in communication with the proximity sensor. The display device displays information from the employee identification device.

The present invention can also be viewed as providing methods for identifying facility employees. In this regard, one embodiment of such a method, among others, can be broadly summarized by the following steps: providing a facility employee with an employee identification device; communicating with the employee identification device from a proximity sensor mounted in a patient room; communicating with the proximity sensor from a display device; and displaying information from the employee identification device on the display device for a patient.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram illustrating general interaction of components of a facility employee identification system, in accordance with a first exemplary embodiment of the invention.

FIG. 2 is a perspective illustration of a patient room utilizing the facility employee identification system of FIG. 1, in accordance with the first exemplary embodiment of the present invention.

FIG. 3 is a block diagram illustrating general interaction of components of a facility employee identification system, in accordance with a second exemplary embodiment of the invention.

FIG. 4 is a flowchart illustrating a method of providing the abovementioned facility employee identification system in accordance with the second exemplary embodiment of the invention.

### DETAILED DESCRIPTION

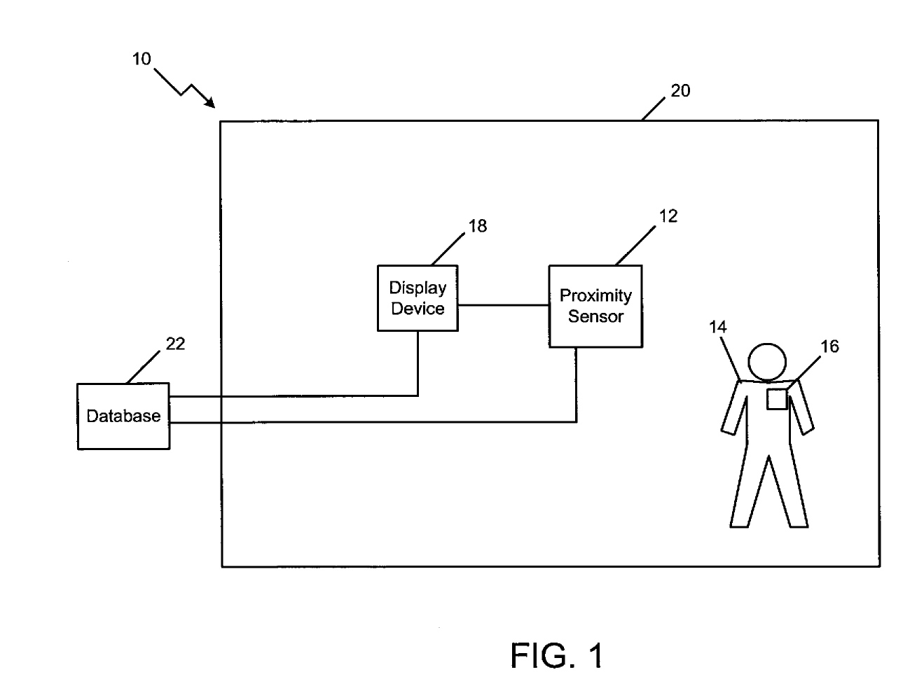

FIG. 1 is a block diagram illustrating general interaction of components of a facility employee identification system 10, in accordance with a first exemplary embodiment of the invention. The facility employee identification system 10 contains a proximity sensor 12 mounted in a patient room. A facility employee 14 wears an employee identification device 16. The employee identification device 16 is in communication with the proximity sensor 12. A display device 18 is in communication with the proximity sensor 12. The display device 18 displays information from the employee identification device 16. The display device 18 and the proximity sensor 12 may be located in a patient room 20 and be in communication with a database 22.

The facility employee 14 may where a name badge that clips to the clothing or is otherwise fastened to the facility employee 14 in a manner operative as an employee identification device 16. The employee identification device 16 may carry an RFID chip, a transmitter, or a similar electronic device that the proximity sensor 12 can sense. The electronic device carried by the employee identification device 16 is, preferably, difficult to remove and communicates a sufficiently individualized signal such that the proximity sensor 12 can identify the intended wearer of the employee identification device 16. The signal sensed by the proximity sensor 12 may be compared with known signals save in a database 22, remote or internal, to identify the intended wearer of the employee identification device 16 and display the identity of the intended wearer on the display device 18 for the benefit of the patient.

The display device 18 is an output device capable of communicating information to a patient. As one example, the display device 18 may be a device that displays a green light when the proximity sensor 12 senses a facility employee 14. The display device 18 may display one or more of the name, title, task, badge number, or other information relevant to the medical staff to help a patient identify the facility employee 14. The display device 18 may also include a screen on which an image of the facility employee 14 may be displayed to allow the patient to positively identify the facility employee 14.

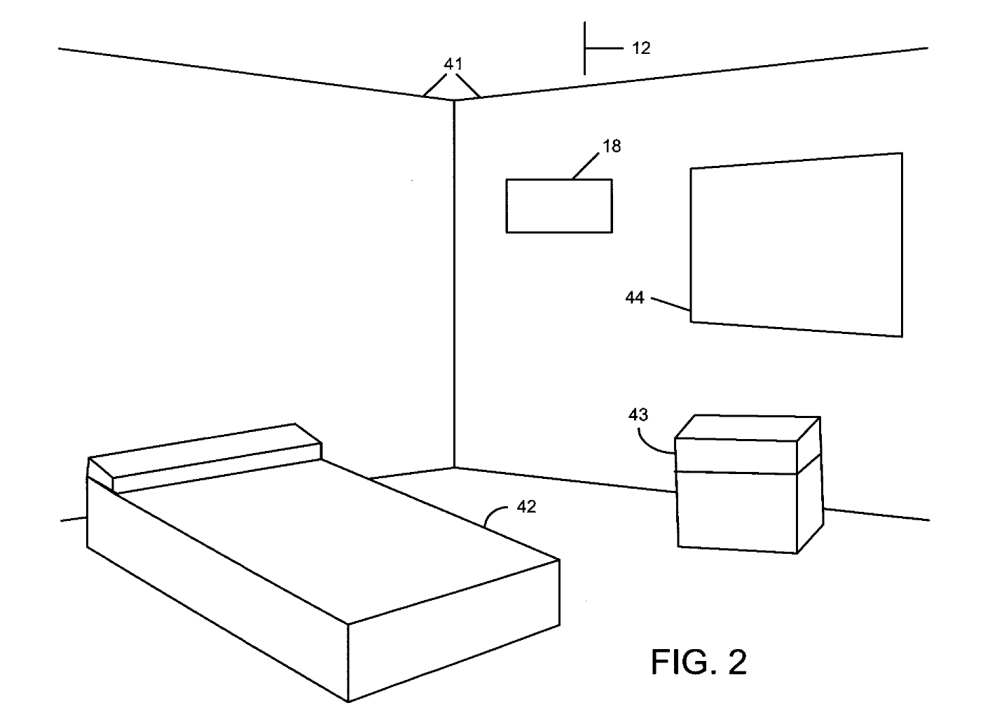

FIG. 2 is a perspective illustration of a patient room 20 utilizing the facility employee identification system 10 of FIG. 1, in accordance with the first exemplary embodiment of the present invention. It should be noted that many elements most healthcare facilities would include in a patient room 20 have been excluded from FIG. 2 to maintain focus on the facility employee identification system 10. As shown in FIG. 2, the proximity sensor 12 may be ceiling mounted, although other locations within the patient room 20 would also allow the invention to operate as described herein.

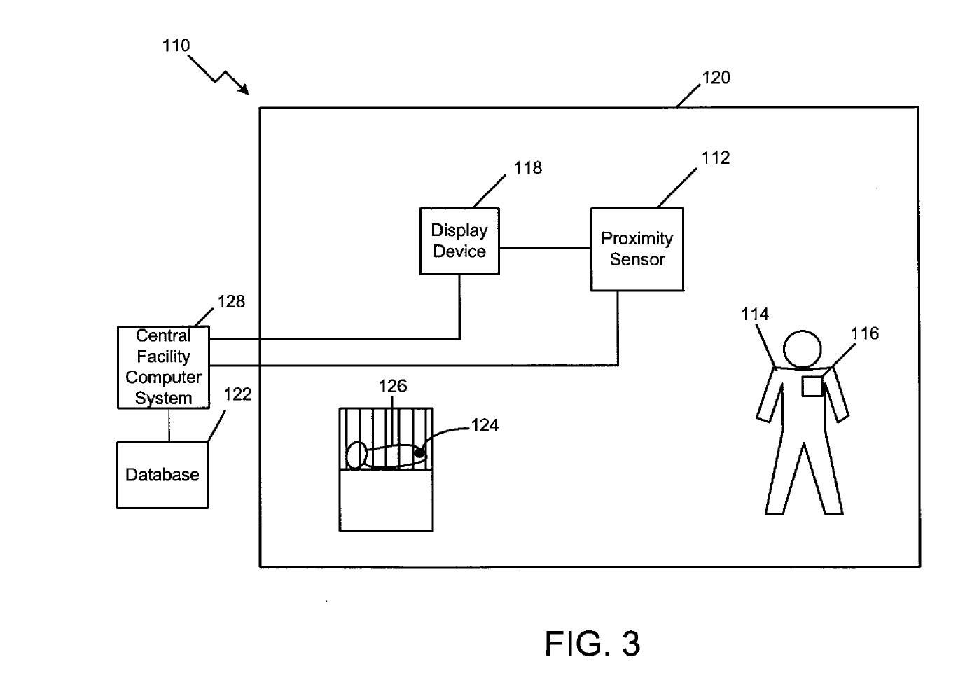

FIG. 3 is a block diagram illustrating general interaction of components of a facility employee 114 identification system 110, in accordance with a second exemplary embodiment of the invention. The facility employee 114 identification system 110 contains a proximity sensor 112 mounted in a patient room. A facility employee 114 wears an employee identification device 116. The employee identification device 116 is in communication with the proximity sensor 112. A display device 118 is in communication with the proximity sensor 112. The display device 118 displays information from the employee identification device 116.

The display device 118 may be a display screen and the information displayed may be a photograph of the facility employee 1 14. The display device 118 may be designed such that when a plurality of facility employees 114 are proximate to the proximity sensor 112 and the plurality of facility employees 114 each have an employee specific identification device 116, the display device 118 forms a split screen showing photographs of the plurality of facility employees 114 concurrently. For similar situations, the display device 1 18 may be designed to display: a count of facility employees 114 recognized by the proximity sensor, names and tasks of each recognized facility employee 114, a duty status of the recognized facility employee 114, or other identification information that would allow a patient to independently verify each individual in the room is a recognized facility employee 114.

The facility employee identification system 110 may be designed specifically for patients, specifically mothers with newborns, in the maternity ward of a hospital. In this arrangement, an infant identification device 124 may be worn by an infant 126 proximate to the proximity sensor 112. The employee identification device 116 may include data identifying whether the facility employee 114 is permitted to handle the infant 126. More specifically, a signal the proximity sensor 112 receives from the employee identification device 116 may be checked with a database 122 to identify the facility employee 114 and the data contained in the database 122 may also instruct whether the facility employee 114 is permitted to handle the infant 126. The display device 118 may indicate for the mother of the infant 126 whether the facility employee 114 is permitted to handle the infant 126. In the case of multiple facility employees 114 in the patient room 120, the display device 118 may identify which facility employees 114 are permitted to handle the infant 126. The display device 118 may further identify which facility employees 114 are authorized to remove the infant 126 from the patient's room 120.

The display device 118 and the proximity sensor 112 may be in communication with a central facility computer system 128. The central facility computer system 128 may be a computer system that oversees operation of the display devices 118 and proximity sensors 112 in multiple patient rooms 120 in a single ward of the facility. The central facility computer system 128 may also be in communication with the database 122 and provide access for updating the database 122. The central facility computer system 128 may be used to input data to the database 122 that will later be displayed on the display devices 118. The central facility computer system 128 may be used to schedule activities for the infant 126, identifying facility employees 114 that will be interacting with the infant 126 and/or removing the infant 126 from the patient room 120.

A plurality of proximity sensors 112 may be located throughout a maternity ward, wherein the display device 118 displays a map of the maternity ward and a location of the infant 126 when the infant 126 is not within the patient room 120, such that the mother of the infant 126 can monitor a location of the infant 126.

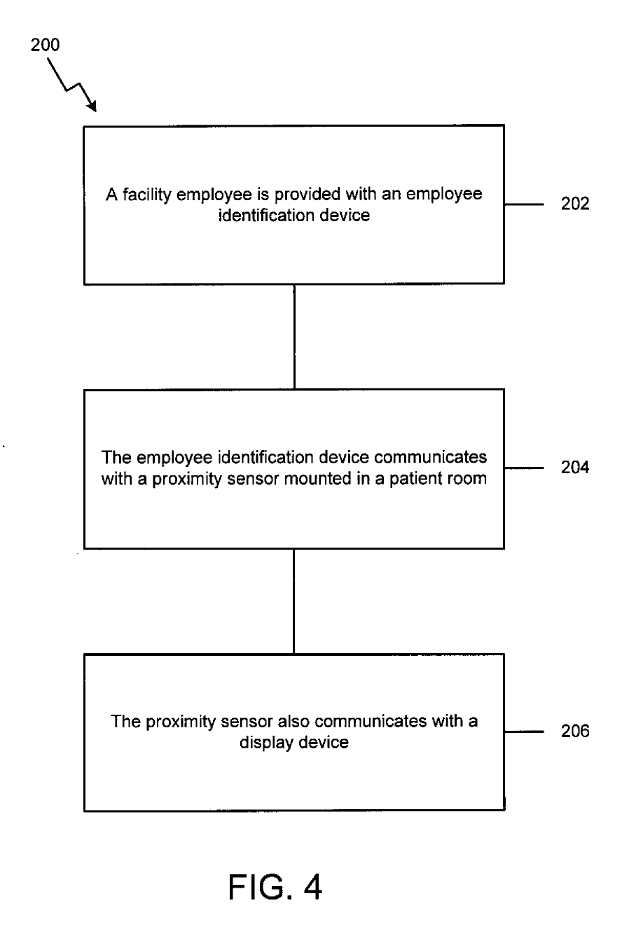

FIG. 4 is a flowchart 200 illustrating a method of providing the abovementioned facility employee identification system 110 in accordance with the second exemplary embodiment of the invention. It should be noted that any process descriptions or blocks in flow charts should be understood as representing modules, segments, portions of code, or steps that include one or more instructions for implementing specific logical functions in the process, and alternate implementations are included within the scope of the present invention in which functions may be executed out of order from that shown or discussed, including substantially concurrently or in reverse order, depending on the functionality involved, as would be understood by those reasonably skilled in the art of the present invention.

As is shown by block 202, a facility employee 114 is provided with an employee identification device 116. The employee identification device 116 communicates with a proximity sensor 112 mounted in a patient room 120 (block 204). The proximity sensor 112 also communicates with a display device 118 (block 206). The display device 118 displays information from the employee identification device 116 for a patient.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A system for identifying facility employees, the system comprising:
a proximity sensor mounted in a patient room;
an employee identification device worn by a facility employee, wherein the employee identification device is in communication with the proximity sensor; and
a display device in communication with the proximity sensor, wherein the display device displays information from the employee identification device.

2. The system of claim 1, wherein the display device is a display screen and the information displayed is a photograph of the facility employee.

3. The system of claim 2, further comprising:
a plurality of facility employees proximate to the proximity sensor;
the plurality of facility employees each have an employee specific identification device; and
the display screen further comprises a split screen showing photographs of the plurality of facility employees concurrently.

4. The system of claim 1, further comprising:
an infant identification device worn by an infant proximate to the proximity sensor;
wherein the employee identification device includes data identifying whether the facility employee is permitted to handle the infant; and
wherein the display device indicates whether the facility employee is permitted to handle the infant.

5. The system of claim 4, wherein the display device and the proximity sensor are networked with a central facility computer system.

6. The system of claim 5, wherein infant care activities are scheduled in the central facility computer system and wherein the display device indicates whether the facility employee is scheduled to take the infant.

7. The system of claim 5, further comprising a plurality of proximity sensors located throughout a maternity ward, wherein the display device displays a map of the maternity ward and a location of the infant when the infant is not within the patient room.

8. The system of claim 1, wherein the information from the employee identification device displayed on the display device includes at least one from the group consisting of: a duty status of the facility employee; an employment position of the facility employee; and a name of the facility employee.

9. A method for identifying facility employees, the method comprising the steps of:
providing a facility employee with an employee identification device;
communicating with the employee identification device from a proximity sensor mounted in a patient room;
communicating with the proximity sensor from a display device; and
displaying information from the employee identification device on the display device for a patient.

10. The method of claim 9, further comprising the step of displaying an image of the facility employee on the display device.

11. The method of claim 10, further comprising the steps of:
utilizing information from the employee identification device to identify the facility employee; and
retrieving the image of the facility employee from a central facility computer system for display on the display device.

12. The method of claim 9, further comprising the steps of:
providing each of a plurality of facility employees with an employee specific identification device;
sensing at least two of the plurality of facility employees proximate to the proximity sensor; and
displaying a split screen concurrently showing photographs of the at least two of the plurality of facility employees.

13. The method of claim 9, further comprising the steps of:
fastening an infant identification device to an infant;
communicating with the infant identification device from the proximity sensor;
providing the employee identification device with data identifying whether the facility employee is permitted to handle the infant; and
displaying on the display device whether the facility employee is permitted to handle the infant.

14. The method of claim 13, further comprising the steps of:
scheduling a care giving activity, that requires the infant, in a central facility computer system;
communicating between the central facility computer system and the display device; and
displaying on the display device the care giving activity for which the facility employee handling the infant.

15. The method of claim 14, further comprising the step of identifying on the display device at least one of the facility employees assigned to the care giving activity.

16. The method of claim 14, further comprising the steps of:
locating a plurality of proximity sensors located throughout a maternity ward;
displaying a map of the maternity ward on the display device; and
displaying a location of the infant when the infant is not within the patient room.
